(19) United States
(12) Patent Application Publication
(10) Pub. No.: US 2013/0183346 A1
(43) Pub. Date: Jul. 18, 2013

(54) UNIQUE TRANSCRIPTIONAL SIGNATURES IN THE BLOOD OF CLINICAL RESPONDERS

(71) Applicants: Anna Karolina Palucka, Dallas, TX (US); Jose Rosello-Urgell, Dallas, TX (US); Jacques F. Banchereau, Montclair, NJ (US); Joseph Fay, Dallas, TX (US); Damien Chaussabel, Bainbridge Island, WA (US)

(72) Inventors: Anna Karolina Palucka, Dallas, TX (US); Jose Rosello-Urgell, Dallas, TX (US); Jacques F. Banchereau, Montclair, NJ (US); Joseph Fay, Dallas, TX (US); Damien Chaussabel, Bainbridge Island, WA (US)

(73) Assignee: BAYLOR RESEARCH INSTITUTE, Dallas, TX (US)

(21) Appl. No.: 13/614,400

(22) Filed: Sep. 13, 2012

Related U.S. Application Data
(60) Provisional application No. 61/533,932, filed on Sep. 13, 2011.

(51) Int. Cl. G06F 19/12

(52) U.S. Cl. CPC G06F 19/12
USPC 424/277.1; 506/9; 702/19

(57) ABSTRACT

A method for using the blood transcriptional profile of patients with stage IV melanoma to generate networks associated with the possibility of prolonged survival and networks associated with clinical responses to dendritic cell (DC) vaccination as measured by tumor regression are disclosed herein.

### CROSS-REFERENCE TO RELATED APPLICATIONS

This application claims priority to U.S. Provisional Application Ser. No. 61/533,932, filed Sep. 13, 2011, the entire contents of which are incorporated herein by reference.

### TECHNICAL FIELD OF THE INVENTION

The present invention relates in general to the field of cancer treatment, and more particularly, to the use of blood transcriptional profiles from melanoma patients to generate networks that help in predicting likelihood of survival, a positive clinical response, and personalize indication of a dendritic cell (DC) vaccines therapy.

### STATEMENT OF FEDERALLY FUNDED RESEARCH

None.

### REFERENCE TO A SEQUENCE LISTING

None.

### BACKGROUND OF THE INVENTION

Without limiting the scope of the invention, its background is described in connection with the treatment of cancer and generation of blood transcriptional profiles to aid in cancer treatment and survival following therapy.

U.S. Patent Application Publication No. 2010/0076691, Palucka et al. (2010) includes compositions, systems and methods for the early detection and consistent determination of metastatic melanoma and/or immunosuppression using microarrays by calculating one or more expression vectors from the expression of one or more genes. The invention discloses a system, method, and apparatus for the diagnosis, prognosis, and tracking of metastatic melanoma and monitoring indicators of immunosuppression associated with transplant recipients (e.g., liver).

U.S. Pat. No. 7,919,261, issued to Fantin et al. (2011) discloses novel biomarkers useful for risk assessment, screening, prognosis and selection, and monitoring of therapy for HDAC mediated cell proliferative disorders. In particular, the invention provides the identities of three particular proteins whose expression patterns are strongly predictive of a particular patient's treatment outcome, e.g., non-responsiveness to SAHA. The expression profile, or pattern, whether embodied in nucleic acid expression, protein expression, or other expression formats will find use in identifying and selecting patients afflicted with a particular HDAC mediated cancer who are likely to be non-responsive to SAHA-based therapy and thus candidates for other treatments.

### SUMMARY OF THE INVENTION

The present invention includes blood transcriptional profiling in patients with stage IV melanoma to generate networks that are associated with the possibility of prolonged survival and networks associated with clinical responses to dendritic cell (DC) vaccination as measured by tumor regression.

### BRIEF DESCRIPTION OF THE DRAWINGS

For a more complete understanding of the features and advantages of the present invention, reference is now made to the detailed description of the invention along with the accompanying figures and in which:

FIG. 1 shows the transcriptional signature obtained from the blood of patients showing a clinical response to dendritic cell (DC) vaccination;

FIG. 2 is an example of a differential baseline gene network in association to clinical response to DC vaccination; and

FIGS. 3A and 3B are differential baseline gene networks in association to survival: FIG. 3A represents a Hazard Ratio >1 and FIG. 3B represents a Hazard Ratio <1.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “cancer” and “cancer cells” refers to any cells that exhibit uncontrolled growth in a tissue or organ of a multicellular organism. The term “breast cancer ” is understood to mean any cancer or cancerous lesion associated with breast tissue or breast tissue cells and can include precursors to breast cancer, for example, atypical ductal hyperplasia or non-atypical hyperplasia. The term “tumor” refers to an abnormal benign or malignant mass of tissue that is not inflammatory and possesses no physiological function.

The terms “melanoma ” or “cutaneous melanoma” refer to malignant neoplasms of melanocytes, which are pigment cells present normally in the epidermis and sometimes in the dermis. There are four types of cutaneous melanoma: Lentigo maligna melanoma; superficial spreading melanoma (SSM); nodular melanoma; and acral lentiginous melanoma (AM). Melanoma usually starts as a proliferation of single melanocytes at the junction of the epidermis and the dermis. The cells first grow in a horizontal manner and settle on an area of the skin that can vary from a few millimeters to several centimeters.

The term “melanoma” includes, but is not limited to, melanomas, metastatic melanomas, melanomas derived from either melanocytes or melanocyte related nevus cells; melanocarcinomas, melanoepitheliomas, melanosarcomas, melanoma in situ, superficial spreading melanoma; nodular melanoma; lentigo maligna melanoma; acral lentiginous melanoma; invasive melanoma; or familial atypical mole and melanoma (FAM-M) syndrome. Such melanomas in mammals may be caused by, chromosomal abnormalities; degenerative growth and developmental disorders; mitogenic agents; ultraviolet radiation (UV); viral infections; inappropriate tissue expression of a gene; alterations in expression of a gene; and presentation on a cell or carcinogenic agents.

As used herein the term “gene” is used to refer to a functional protein, polypeptide or peptide-encoding unit. As will be understood by those in the art, this functional term includes both genomic sequences, cDNA sequences, fragments or combinations thereof, as well as gene products, including those that may have been altered by the hand of man. Purified genes, nucleic acids, protein, and the like are used to refer to these entities when identified and separated from at least one contaminating nucleic acid or protein with which it is ordinarily associated.

The term “transcriptional profile” refers to the expression levels of a set of genes in a cell in a particular state, particularly by comparison with the expression levels of that same set of genes in a cell of the same type in a reference state. For example, the transcriptional profile of a particular polypeptide in a suspension cell is the expression levels of a set of genes in a cell knocking out or overexpressing that polypeptide compared with the expression levels of that same set of genes in a suspension cell that has normal levels of that polypeptide. The transcriptional profile can be presented as a list of those genes whose expression level is significantly different between the two treatments, and the difference ratios. Differences and similarities between expression levels may also be evaluated and calculated using statistical and clustering methods.

The term “microarray” in the broadest sense refers to a substrate in which specific molecules are densely immobilized in a predetermined region. Examples of the microarray include, for example, a polynucleotide microarray and a protein microarray. The term “polynucleotide microarray” refers to a substrate on which polynucleotides are densely immobilized in each predetermined region. The microarray is well known in the art, for example, U.S. Pat. Nos. 5,445,934 and 5,744,305. The term also includes all the devices so called in Schena (ed.), DNA Microarrays: A Practical Approach (Practical Approach Series), Oxford University Press (1999) (ISBN: 0199637768); Nature Genet. 21(1)(suppl):1-60 (1999); and Schena (ed.), Microarray Biochip: Tools and Technology, Eaton Publishing Company/BioTechniques Books Division (2000) (ISBN: 1881299376), the disclosures of which are incorporated herein by reference in their entirety.

As used herein the term “modify” or “modifies” is meant to include up or down regulation of the function of a gene or gene product, e.g., affecting the transcription, translation, processing, release or modification of a gene or gene product. Examples of modification include, e.g., transcriptional or post-transcriptional silencing, changes to message stability and the like. Examples of post-translational modifications include maturation of the gene product or protein, post-translational modifications (e.g., glycosylation; di-sulfide bonding; myristylation; protease cleavage; association with other proteins; ubiquitination; etc.). The processing, transport and release of the protein may also be modified, e.g., by placing in storage organelles prior to release, by association with other proteins that affect release and the like.

The term “diagnosis” or “diagnostic test” for the purpose of the instant invention refers to the identification of the disease at any stage of its development, i.e., it includes the determination of whether an individual has the disease or not and/or includes determination of the stage of the disease.

As used herein the term “biomarker” refers to a specific biochemical in the body that has a particular molecular feature to make it useful for diagnosing and measuring the progress of disease or the effects of treatment. For example, common metabolites or biomarkers found in a person's breath, and the respective diagnostic condition of the person providing such metabolite include, but are not limited to, acetaldehyde; (source: Ethanol, X-threonine; diagnosis: Intoxication); acetone (source: Acetoacetate; diagnosis: Diet/diabetes); ammonia (source: Deamination of amino acids; diagnosis: Uremia and liver disease); CO (carbon monoxide) (source: CH₂Cl₂, elevated % COHb; diagnosis: Indoor air pollution); chloroform (source: Halogenated compounds); dichlorobenzene (source: Halogenated compounds); diethylamine (source: Choline; diagnosis: Intestinal bacterial overgrowth); H (hydrogen) (source: Intestines; diagnosis: Lactose intolerance); isoprene (source: Fatty acid; diagnosis: Metabolic stress); methanethiol (source: Methionine; diagnosis: Intestinal bacterial overgrowth); methylethylketone (source: Fatty acid; diagnosis: Indoor air pollution/diet); O-toluidine (source: Carcinoma metabolite; diagnosis: Bronchogenic carcinoma); pentane sulfides and sulfides (source: Lipid peroxidation; diagnosis: Myocardial infarction); H2S (source: Metabolism; diagnosis: Periodontal disease/ovulation); MeS (source: Metabolism; diagnosis: Cirrhosis); and Me₂S (source: Infection; diagnosis: trench mouth).

As used herein, the term “treatment” or “treating” refers to administration of a compound of the present invention and includes (1) inhibiting the disease in an animal that is experiencing or displaying the pathology or symptomatology of the diseased (i.e., arresting further development of the pathology and/or symptomatology), or (2) ameliorating the disease in an animal that is experiencing or displaying the pathology or symptomatology of the diseased (i.e., reversing the pathology and/or symptomatology). The term “controlling” includes preventing; treating; eradicating; ameliorating; or otherwise reducing the severity of the condition being controlled.

As used herein, the term “in vivo” refers to being inside the body. The term “in vitro” used as used in the present application is to be understood as indicating an operation carried out in a non-living system.

As used herein, the term “chemotherapeutic” anti-cancer agents are those agents that reduce or eliminate cancer cells and may include, e.g., alkylating/carbamylating agents; platinum derivatives; antimitotic agents; tubulin inhibitors; topoisomerase inhibitors; nucleotide or nucleoside antagonists such as pyrimidine or purine antagonists; and folic acid antagonists.

As used herein, the term “target-specific” anti-cancer agents include those that specifically target cancer cells and include, e.g., taxanes, kinase inhibitors; phosphatase inhibitors; proteasome inhibitors; histone deacetylase inhibitors; heat shock protein inhibitors; vascular targeting agents (VAT); monoclonal antibodies (e.g., Trastuzumab; Rituximab; Alemtuzumab; Tositumomab; Cetuxcimab; Bevacizumab), as well as mutants, fragments and conjugates of monoclonal antibodies (e.g., Gemtuzumab ozogamicin or Ibritumomab tiuxetan);

oligonucleotide based therapeutics; Toll-like receptor agonists; protease inhibitors; anti-estrogens hormonal therapeutics; anti-androgens hormonal therapeutics; luteinizing-hormone releasing hormone (LHRH) agents (e.g., Leuprorelin, Goserelin, Triptorelin); aromatase inhibitors; bleomycin; retinoids; DNA methyltransferase inhibitors; alanosine; cytokines; interferons; and death receptor agonists. In one example, the tumor can be a breast cancer and the agent directed to the breast cancer.

Non-limiting examples of anti-cancer agents that may be useful in a combination therapy according to the present invention include, e.g., Actinomycin D; Abarelix, Abciximab, Aclarubicin, Adapalene, Alemtuzumab, Altretamine, Aminoglutethimide, Amiprilose; Amrubicin; Anastrozole; Ancitabine; Artemisinin; Azathioprine; Basiliximab; Bendamustine; Bevacizumab; Bexxar; Bicalutamide; Bleomycin; Bortezomib; Broxuridine; Busulfan; Campath; Capecitabine; Carboplatin; Carboquone; Carmustine; Cetrorelix; Chloram-Bucil; Chlormethine; Cisplatin; Cladribine; Clomifene; Cyclophosphamide; Dacarbazine; Daclizumab; Dactinomycin; Daunorubicin; Decitabine; Deslorelin; Dexrazoxane; Docetaxel; Doxifluridine; Doxorubicin; Droloxifene; Drostanolone; Edelfosine; Eflornithine; Emitefur; Epirubicin; Epitiostanol; Eptaplatin; Erbitux; Erlotinib; Estramustine; Etoposide; Exemestane; Fadrozole; Finasteride; Floxuridine; Flucytosine; Fludarabine; Fluorouracil; Flutamide; Formestane; Foscarnet; Fosfestrol; Fotemustine; Fulvestrant; Gefitinib; Genasense; Gemcitabine; Glivec; Goserelin; Gusperimus; Herceptin; Idarubicin; Idoxuridine; Ifosfamide; Imatinib; Improsulfan; Infliximab; Irinotecan; Ixabepilone; Lanreotide; Letrozole; Leuprorelin; Lobaplatin; Lomustine; Luprolide; Melphalan; Mercaptopurine; Methotrexate; Meturedepa; Miboplatin; Mifepristone; Miltefosine; Mirimostim; Mitoguazone; Mitolactol; Mitomycin; Mitoxantrone; Mizoribine; Motexafin; Mylotarg; Nartograstim; Nebazumab; Nedaplatin; Nilutamide; Nimustine; Octreotide; Ormeloxifene; Oxaliplatin; Paclitaxel; Palivizumab; Patupilone; Pegaspargase; Pegfilgrastim; Pemetrexed; Pentetreotide; Pentostatin; Perfosfamide; Piposulfan; Pirarubicin; Plicamycin; Prednimustine; Procarbazine; Propagermanium; Prospidium Chloride; Raloxifen; Raltitrexed; Ranimustine; Ranpirnase; Rasburicase; Razoxane; Rituximab; Rifampicin; Ritrosulfan; Romurtide; Ruboxistaurin; Sargramostim; Satraplatin; Sirolimus; Sobuzoxane; Sorafenib; Spiromustine; Streptozocin; Sunitinib; Tamoxifen; Tasonermin; Tegafur; Temoporfin; Temozolomide; Teniposide; Testolactone; Thiotepa; Thymalfasin; Tiamiprine; Topotecan; Toremifene; Trail; Trastuzumab; Treosulfan; Triaziquone; Trimetrexate; Triptorelin; Trofosfamide; Uredepa; Valrubicin; Vatalanib; Verteporfin; Vinblastine; Vincristine; Vindesine; Vinorelbine; Vorozole; and Zevalin. The person skilled in the art is aware on the bases of his/her expert knowledge of the total daily dosage(s) and administration form(s) of the additional therapeutic agent(s) co-administered with the active agents of the present invention and in the methods taught herein. The total daily dosage(s) can vary within a wide range.

The present invention describes blood transcriptional profiling in patients with stage IV melanoma thereby allowing the generation of networks that are associated with the possibility of prolonged survival and networks associated with clinical responses to dendritic cell (DC) vaccination as measured by tumor regression.

The present invention will aid in: (i) identification of melanoma patients with a higher probability of prolonged survival, by analyzing the pathways or gene networks obtained by blood transcriptional profiling, (ii) allow early evaluation of patients with a higher probability of clinical response to dendritic cell (DC) vaccination, and (iii) personalize the indication for DC vaccination based on the a priori risk of good clinical response.

From a randomized controlled trial aimed to test the immune response and the clinical efficacy of a dendritic cell vaccine loaded with killed allogenic melanoma cells, in patients diagnosed with stage IV melanoma, the present inventor's analyzed changes in whole blood gene expression profiles over time. During follow-up of patients, peripheral blood samples were taken in a systematic way at the time of vaccination, making it possible to study the association between vaccination and changes in gene expression profiles.

Differences in gene expression values were assessed by using JMP Genomics V5. This application allows the use of general mixed model analysis for the study of differential gene expression in a row-by-row fashion. This type of analysis is appropriate for the study of change over time, being able to adjust for repeated measures in the same units of observation. In order to control for multiple testing, we used a false discovery rate (FDR) of 0.05.

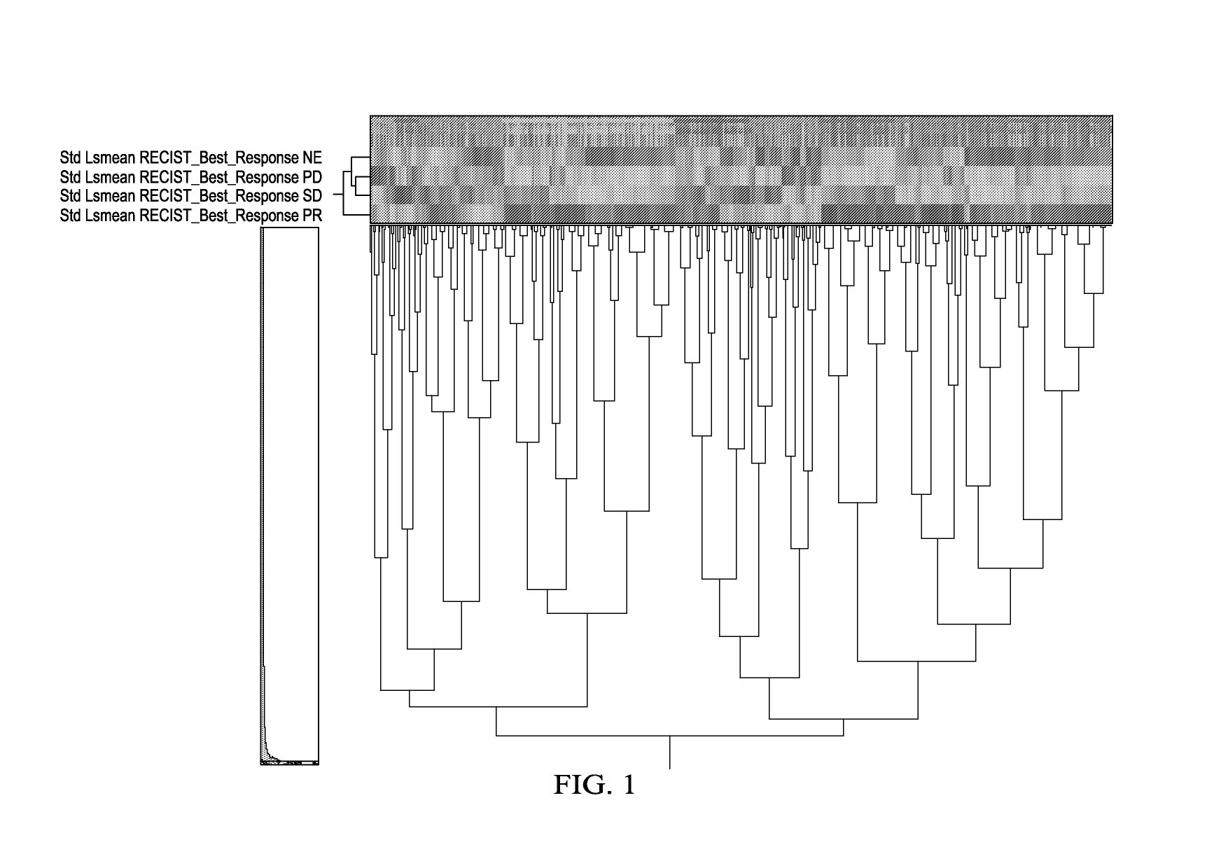

As a result of the application of the mixed models, the inventors were able to elaborate a cluster analysis of the significant genes, and of the variables under study. Heat map for the variable “best clinical response” and the differentially expressed genes is provided in FIG. 1.

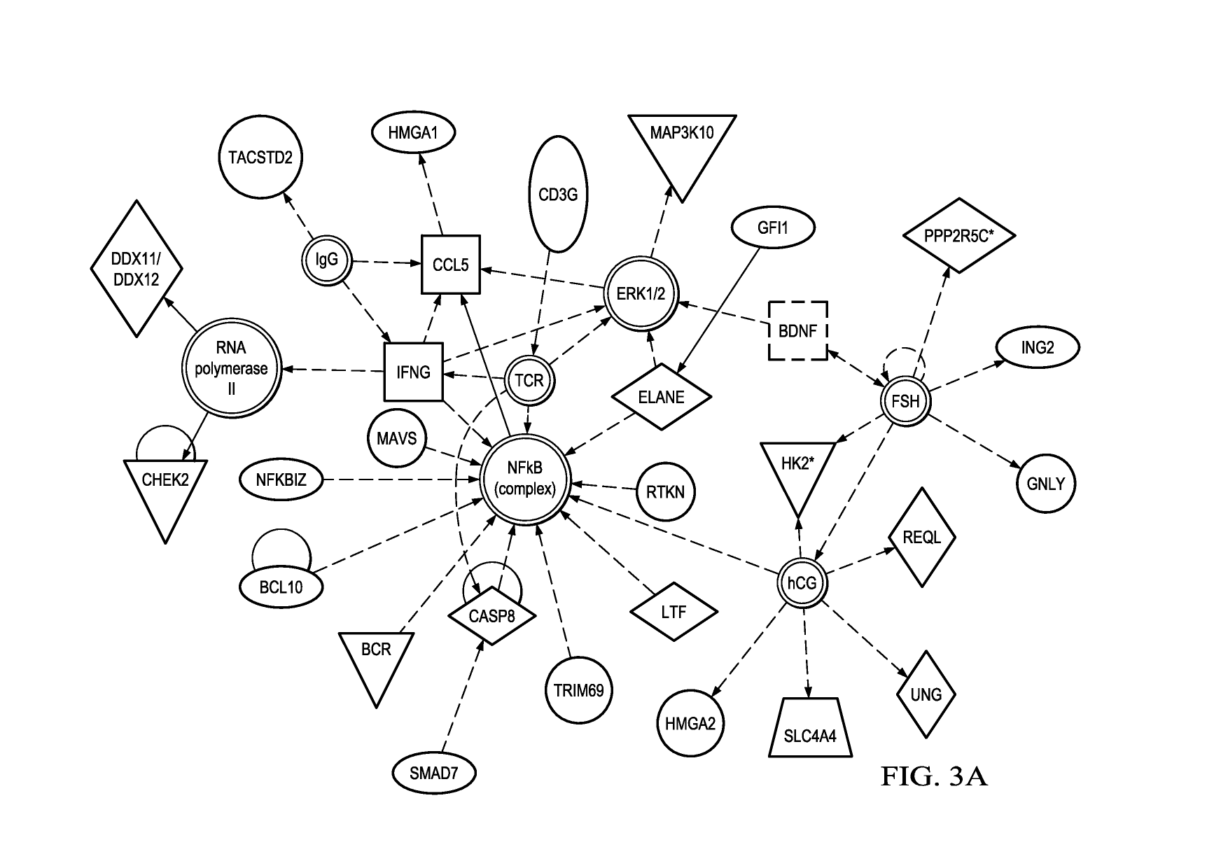

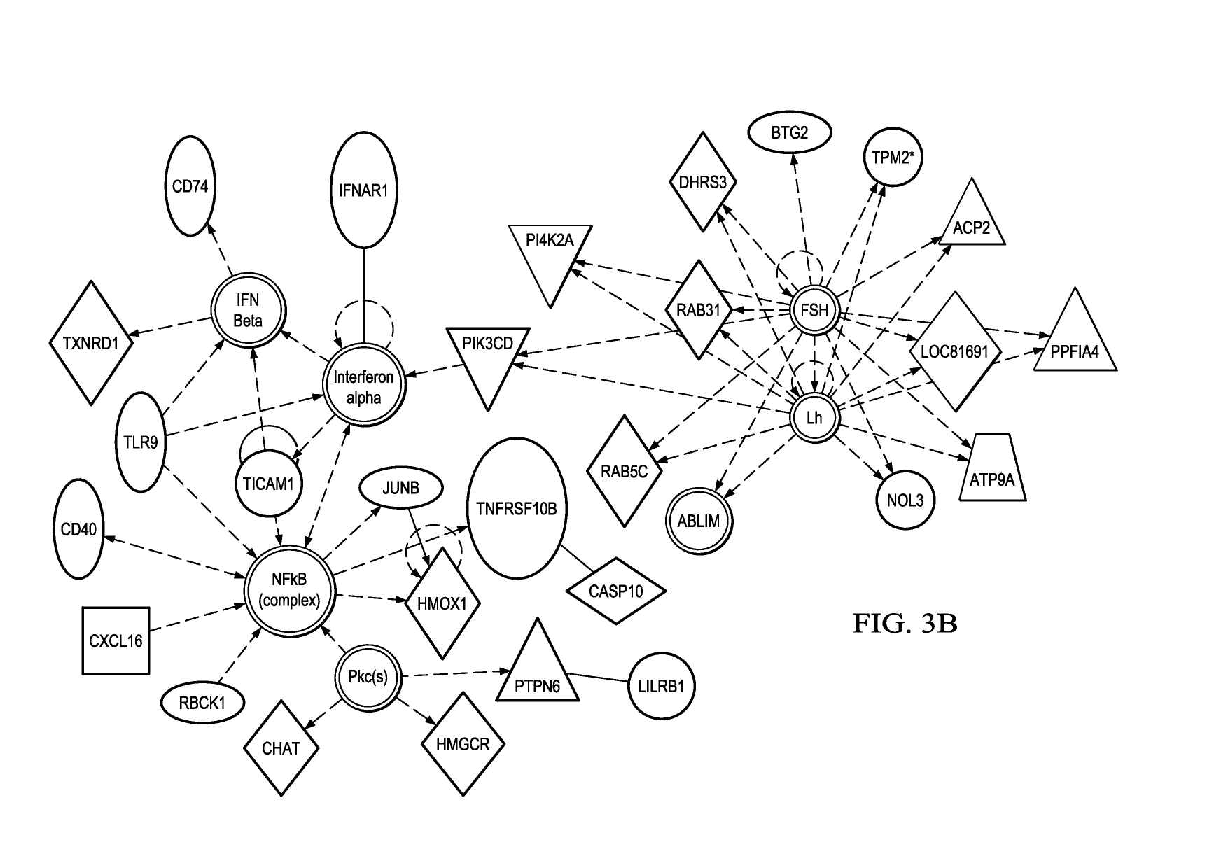

In order to study the association with gene expression and survival, the inventors also applied the survival analysis methodology provided by the same JMP Genomics program. This type of analysis allowed the identification of genes which, at baseline, are associated with an increased risk of dying (hazard ratio >1, FIG. 3A) or with a decreased risk (hazard ratio <1, FIG. 3B).

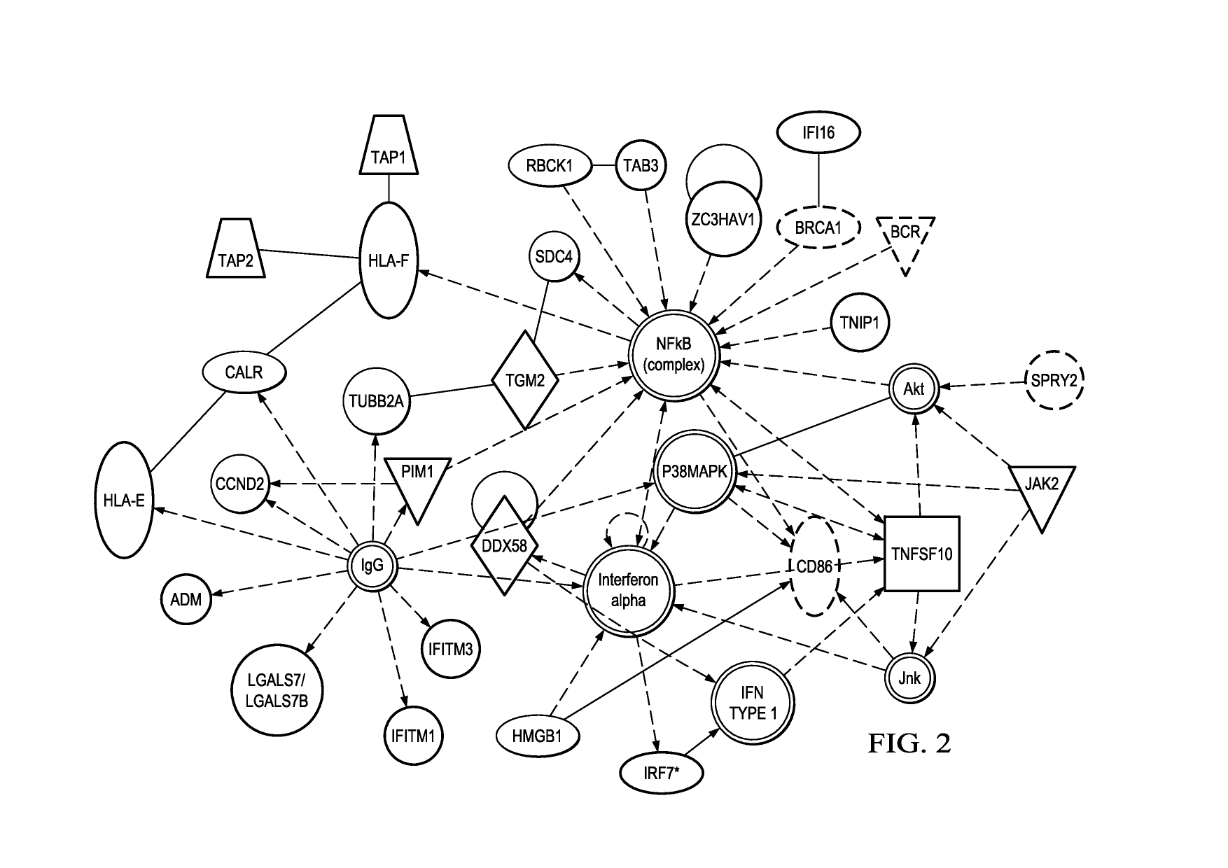

Differentially expressed genes were uploaded to IPA (Ingenuity Pathway Analysis), to generate networks and to identify pathways associated with the genes involved in the identification of patients with a higher probability of survival, and with those genes associated with a differential risk of survival based on the response to the vaccine of dendritic cells (FIG. 2).

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial,” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Patent Application Publication No. 2010/0076691: Diagnosis of Metastatic Melanoma and Monitoring Indicators of Immunosuppression Through Blood Leukocyte Microarray Analysis.

U.S. Pat. No. 7,919,261: Methods for Predicting Treatment Response Based on the Expression Profiles of Protein and Transcription Biomarkers.

What is claimed is:

1. A method for generating a gene network indicative of responsiveness to a cancer treatment comprising the steps of:
obtaining one or more biological samples from a patient or a population of patients showing responsiveness to the cancer treatment, wherein the biological sample is selected from the group consisting of stool sputum, pancreatic fluid, bile, lymph, blood, urine, cerebrospinal fluid, seminal fluid, saliva, breast nipple aspirate, and pus;
generating a transcriptional profile from the isolated biological sample by a method comprising the steps of:
isolating a total RNA from the biological sample;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA;
comparing the generated transcriptional profile with the transcriptional profile of a control subject, wherein the control subject may be a healthy subject, a subject non-responsive to the cancer treatment, or any combinations thereof; and
mapping or generating a network of genes responsible for the responsiveness to the cancer treatment based on differences in the generated transcriptional profiles between the control subject and the patient or patient population.

2. The method of claim 1, wherein the cancer is melanoma.

3. The method of claim 1, wherein the biological sample is a blood sample.

4. The method of claim 1, wherein the cancer treatment comprises vaccination with a dendritic cell (DC) vaccine.

5. The method of claim 1, wherein responsiveness to the cancer treatment is measured by monitoring tumor regression.

6. A method for generating a gene network indicative of responsiveness to a dendritic cell (DC) vaccine against melanoma comprising the steps of:
obtaining blood from a melanoma patient or a population of patients showing responsiveness to the cancer treatment, wherein a tumor regression is indicative of responsiveness to the melanoma treatment;
generating a transcriptional profile from the blood by a method comprising the steps of:
isolating a total RNA from the blood;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA;
comparing the generated transcriptional profile with the transcriptional profile of a control subject, wherein the control subject may be a healthy subject, a subject non-responsive to the melanoma treatment, or any combinations thereof; and
mapping or generating a network of genes responsible for the responsiveness to the melanoma treatment based on differences in the generated transcriptional profiles between the control subject and the patient or patient population.

7. A method for generating a gene network for predicting likelihood of a positive prognosis, survival, or both in cancer comprising the steps of:
obtaining one or more biological samples from a cancer surviving patient or a population of patients, wherein the biological sample is selected from the group consisting of stool, sputum, pancreatic fluid, bile, lymph, blood, urine, cerebrospinal fluid, seminal fluid, saliva, breast nipple aspirate, and pus;
generating a transcriptional profile from the isolated biological sample by a method comprising the steps of:
isolating a total RNA from the biological sample;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA;
comparing the generated transcriptional profile with the transcriptional profile of a control subject, wherein the control subject may be a healthy subject, a subject non-responsive to the cancer treatment, a deceased subject, or any combinations thereof; and
mapping or generating a network of genes responsible for the likelihood of a positive prognosis, survival, or both based on differences in the generated transcriptional profiles between the control subject and the cancer surviving patient or a population of patients.

8. The method of claim 7, wherein the cancer is melanoma.

9. The method of claim 7, wherein the biological sample is a blood sample.

10. A method for generating a gene network for predicting the likelihood of a positive prognosis, survival, or both in a melanoma comprising the steps of:
obtaining blood from a melanoma surviving patient or a population of patients;
generating a transcriptional profile from the blood by a method comprising the steps of:
isolating a total RNA from the blood;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA;
comparing the generated transcriptional profile with the transcriptional profile of a control subject, wherein the control subject may be a healthy subject, a subject non-responsive to the melanoma treatment, a deceased subject, or any combinations thereof; and
mapping or generating a network of genes responsible for the likelihood of a positive prognosis, survival, or both based on differences in the generated transcriptional profiles between the control subject and the melanoma surviving patient or a population of patients.

11. A method for selecting a candidate for a clinical trial, a therapy, or any combinations thereof against one or more cancers based on prediction of the likelihood for survival comprising the steps of:
obtaining a blood sample from the candidate;
generating a transcriptional profile from the isolated blood sample;
generating one or more gene networks from the transcriptional profile;
detecting presence of one or more genes indicative of prolonged survival in the transcriptional profile;
selecting the candidate for the clinical trial, the therapy, or any combinations thereof against the one or more cancers based on the presence of the one or more genes indicative of prolonged survival.

12. The method of claim 11, wherein the step of generating a transcriptional profile comprises the steps of:
isolating a total RNA from the biological sample;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA.

13. The method of claim 11, wherein the cancer is melanoma.

14. The method of claim 11, wherein the therapy comprises vaccination with a dendritic cell (DC) vaccine.

15. A method for a priori prediction of response to a cancer therapy regimen in a patient or a patient population comprising the steps of:
obtaining a blood sample from the patient or patient population;
generating a transcriptional profile from the isolated blood sample;
generating one or more gene networks from the transcriptional profile;
detecting presence of one or more genes indicative of a positive or a negative response to the cancer therapy in the transcriptional profile;
administering, modifying, or terminating the therapy regimen based on a presence or absence of one or more genes or gene sets in the transcriptional profile.

16. The method of claim 15, wherein the step of generating a transcriptional profile comprises the steps of:
isolating a total RNA from the biological sample;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA.

17. The method of claim 15, wherein the cancer is melanoma.

18. The method of claim 15, wherein the therapy comprises vaccination with a dendritic cell (DC) vaccine.

19. A method of personalizing a dendritic cell (DC) vaccine therapy against melanoma in a patient comprising the steps of:
obtaining a blood sample from the patient suffering from melanoma;
generating a transcriptional profile from the isolated blood sample;
generating one or more gene networks from the transcriptional profile;
detecting presence of one or more genes or gene sets indicative of a positive response, survival, or both to the DC vaccine therapy in the transcriptional profile;
administering the DC vaccine therapy to the patient;
obtaining a blood sample after vaccination with the DC vaccine;
generating the transcriptional profile of the blood sample isolated after vaccine;
detecting a continued presence of one or more genes indicative of a positive response, survival, or both to the DC vaccine therapy in the transcriptional profile of the patient; and
modifying a DC vaccine composition if necessary based on the blood transcriptional profile post vaccination.

20. The method of claim 19, wherein the step of generating a transcriptional profile comprises the steps of:
isolating a total RNA from the biological sample;
labeling and hybridizing the isolated RNA;
loading the labeled and hybridized RNA on a solid substrate, wherein the solid substrate is selected from the group consisting of glass, silicon, beads, or any combinations thereof;
scanning the loaded RNA in the microarray system; and
generating a transcriptional profile from the RNA.
